(19) United States
(12) Patent Application Publication
(10) Pub. No.: US 2021/0383304 A1
(43) Pub. Date: Dec. 9, 2021

(54) METHOD AND APPARATUS FOR IMPROVING RISK PROFILE FOR INFORMATION TECHNOLOGY CHANGE MANAGEMENT SYSTEM

(71) Applicant: JPMorgan Chase Bank, N.A., New York, NY (US)

(72) Inventors: Nicolas AQUILIZAN, Katy, TX (US); Jonathan ORMEROD, Hampton (GB); Mitchelle SANGHVI, London (GB); Patrick UNDERWOOD, Westerville, OH (US)

(73) Assignee: JPMorgan Chase Bank, N.A., New York, NY (US)

(21) Appl. No.: 17/340,470

(22) Filed: Jun. 7, 2021

Related U.S. Application Data
(60) Provisional application No. 63/035,261, filed on Jun. 5, 2020.

(51) Int. Cl. G06Q 10/06; G06N 20/00; G06F 16/26

(52) U.S. Cl. CPC G06Q 10/06375; G06F 16/26; G06N 20/00; G06Q 10/0635

(57) ABSTRACT

Various methods, apparatuses/systems, and media for improving risk profile for information technology (IT) change management are disclosed. A processor establishes a communication link with a plurality of data sources and a receiver. The receiver receives input of change management data associated with an IT change management system via an API. The processor sets a scoring scale and applies big data and machine learning algorithm to the input of change management data. The application of big data includes collecting, by the processor, the API associated with the input of change management data from the plurality of data sources. The processor also calculates a risk profile for the IT change management system corresponding to the input of change management data based on the scoring scale and automatically generates a risk matrix having a predetermined dimension based on the calculated risk profile. The processor also integrates results from the models into other vendor products used for change management.

### CROSS-REFERENCE TO RELATED APPLICATIONS

This application claims the benefit of priority from U.S. Provisional Patent Application No. 63/035,261, filed Jun. 5, 2020, which is herein incorporated by reference in its entirety.

### TECHNICAL FIELD

This disclosure generally relates to Information Technology (IT) change management, and, more particularly, to methods and apparatuses for implementing an IT change management module for automatically calculating a risk profile based on a scoring scale by utilizing big data and machine learning algorithm, thereby improving the risk profile for IT change management system.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Typically, many organizations implement solutions to manage the process of requesting, planning, and implementing changes to their IT infrastructure. Sometimes, multiple, related changes must be made to software and/or hardware components of the infrastructure. Risk management generally relates to procedures for assessing and managing risk associated with IT change management system that are established by the organization, with accompanying manual directives by management to comply with the procedures. Current change risk profile may not be accurately assessed for risk due to manual assessment of risk. For example, higher risk changes may be incorrectly tagged at a lower risk profile.

For example, a production management team may spend a lot of time and effort on proactive measures to improve the stability of production and reduce the potential for service disruptions. Often it may prove to be extremely difficult to know how best to direct this effort or how to target stability and quality improvements to where it is most needed. A data driven approach may be utilized to identify applications that may require attention. Using a programmatic rules-based approach, various leading indicators are reviewed, and additional scrutiny is brought to applications with increasing trends.

There is a need in leveraging data science techniques to discover meaningful relationships and patterns in production data aimed at predicting failed change and change related incidents, without requiring a significant amount manual effort.

### SUMMARY

The present disclosure, through one or more of its various aspects, embodiments, and/or specific features or sub-components, may provide, among others, various systems, servers, devices, methods, media, programs, and platforms for implementing an IT change management module for automatically calculating a risk profile based on a scoring scale by utilizing big data and machine learning algorithm, thereby improving the risk profile for IT change management system, but the disclosure is not limited thereto. The present disclosure, through one or more of its various aspects, embodiments, and/or specific features or sub-components, may also provide, among others, various systems, servers, devices, methods, media, programs, and platforms for implementing an IT change management module for automatically calculating a risk profile based on a scoring scale by utilizing big data and machine learning algorithm (i.e., artificial intelligence (AI)/machine learning (ML) models), thereby reducing downtime by focusing on true high and critical risk changes; resulting reduction in client/customer impacts by avoiding manual entry and incorrect risk assessment; and increasing in production stability due to increased awareness of high and critical risk changes, but the disclosure is not limited thereto.

According to an aspect of the present disclosure, the claimed embodiments can be utilized for small to large scale implementations. For example, a large scale implementation of the claimed embodiments may include handling hundreds and thousands of critical risk changes on an annual basis, but the disclosure is not limited thereto.

According to an aspect of the present disclosure, a method for improving risk profile for IT change management system by utilizing one or more processors and one or more memories is disclosed. The method may include: receiving input of change management data associated with an IT change management system via an application programming interface (API); setting a scoring scale; applying big data and machine learning algorithm to the input of change management data, wherein application of big data includes collecting the API associated with the input of change management data from a plurality of data sources; calculating a risk profile for the IT change management system corresponding to the input of change management data based on the scoring scale; and automatically generating a risk matrix having a predetermined dimension based on the calculated risk profile.

According to another aspect of the present disclosure, the method may further include: setting a scoring scale having numerical values within a range of 1-100; calculating the risk profile based on the numerical values within the range of 1-100, and dynamically updating the risk matrix as new scoring values are generated.

According to yet another aspect of the present disclosure, the method may further include: assigning a risk profile of low for the IT change management system when the application of big data and machine learning algorithm to the input of change management data returns a scoring value within the range of 0-59; and entering the assigned risk profile of “low” into the risk matrix.

According to an additional aspect of the present disclosure, the method may further include: assigning a risk profile of medium for the IT change management system when the application of big data and machine learning algorithm to the input of change management data returns a scoring value within the range of 60-79; and entering the assigned risk profile of “medium” into the risk matrix.

According to yet another aspect of the present disclosure, the method may further include: assigning a risk profile of medium for the IT change management system when the application of big data and machine learning algorithm to the input of change management data returns a scoring value within the range of 80-100; and entering the assigned risk profile of “high” into the risk matrix.

According to an additional aspect of the present disclosure, the method may further include iteratively retraining of ML models; and updating future predictions based on the retrained ML models.

According to a further aspect of the present disclosure, the method may further include: implementing ensemble learning that combines predictions from an ensemble of multiple machine learning classifiers; and determining, in response to implementing, a final prediction by majority voting.

According to yet another aspect of the present disclosure, the method may further include: training the ensemble of multiple machine learning classifiers in parallel; and generating the final prediction by using a hard voting classifier to determine majority consensus of all classifiers.

According to a further aspect of the present disclosure, the method may further include: splitting historical change data into groups based on values of predictor variables; implementing different sequences of splits until division of failures and non-failures are obtained that meet the predetermined dimension resulting a decision tree; and implementing the decision tree to classify pending changes as failures or successes.

According to a further aspect of the present disclosure, a system for improving risk profile for information technology (IT) change management is disclosed. The system may include a plurality of data sources including memories; and a processor operatively connected to the plurality of data sources via a communication network. The processor may be configured to: receive input of change management data associated with an IT change management system via an application programming interface (API); set a scoring scale; apply big data and machine learning algorithm to the input of change management data, wherein application of big data includes collecting the API associated with the input of change management data from a plurality of data sources; calculate a risk profile for the IT change management system corresponding to the input of change management data based on the scoring scale; and automatically generate a risk matrix having a predetermined dimension based on the calculated risk profile.

According to another aspect of the present disclosure, the processor may be further configured to: set a scoring scale having numerical values within a range of 1-100, calculating the risk profile based on the numerical values within the range of 1-100; and dynamically update the risk matrix as new scoring values are generated.

According to yet another aspect of the present disclosure, the processor may be further configured to: assign a risk profile of low for the IT change management system when the application of big data and machine learning algorithm to the input of change management data returns a scoring value within the range of 0-59; and enter the assigned risk profile of “low” into the risk matrix.

According to an additional aspect of the present disclosure, the processor may be further configured to: assign a risk profile of medium for the IT change management system when the application of big data and machine learning algorithm to the input of change management data returns a scoring value within the range of 60-79; and enter the assigned risk profile of “medium” into the risk matrix.

According to yet another aspect of the present disclosure, the processor may be further configured to: assign a risk profile of medium for the IT change management system when the application of big data and machine learning algorithm to the input of change management data returns a scoring value within the range of 80-100; and enter the assigned risk profile of “high” into the risk matrix.

According to an additional aspect of the present disclosure, the processor may be further configured to iteratively retrain ML models; and update future predictions based on the retrained ML models.

According to a further aspect of the present disclosure, the processor may be further configured to: implement ensemble learning that combines predictions from an ensemble of multiple machine learning classifiers; and determine, in response to implementing, a final prediction by majority voting.

According to yet another aspect of the present disclosure, the processor may be further configured to: train the ensemble of multiple machine learning classifiers in parallel; and generate the final prediction by using a hard voting classifier to determine majority consensus of all classifiers.

According to a further aspect of the present disclosure, the processor may be further configured to: split historical change data into groups based on values of predictor variables; implement different sequences of splits until division of failures and non-failures are obtained that meet the predetermined dimension resulting a decision tree, and implement the decision tree to classify pending changes as failures or successes.

According to an additional aspect of the present disclosure, a non-transitory computer readable medium configured to store instructions for improving risk profile for IT change management system is disclosed. The instructions, when executed, may cause a processor to perform the following: receiving input of change management data associated with an IT change management system via an application programming interface (API); setting a scoring scale; applying big data and machine learning algorithm to the input of change management data, wherein application of big data includes collecting the API associated with the input of change management data from a plurality of data sources; calculating a risk profile for the IT change management system corresponding to the input of change management data based on the scoring scale; and automatically generating a risk matrix having a predetermined dimension based on the calculated risk profile.

According to another aspect of the present disclosure, when executed, the instructions may further cause the processor to perform the following: setting a scoring scale having numerical values within a range of 1-100; calculating the risk profile based on the numerical values within the range of 1-100; and dynamically updating the risk matrix as new scoring values are generated.

According to yet another aspect of the present disclosure, when executed, the instructions may further cause the processor to perform the following: assigning a risk profile of low for the IT change management system when the application of big data and machine learning algorithm to the input of change management data returns a scoring value within the range of 0-59; and entering the assigned risk profile of “low” into the risk matrix.

According to an additional aspect of the present disclosure, when executed, the instructions may further cause the processor to perform the following: assigning a risk profile of medium for the IT change management system when the application of big data and machine learning algorithm to the input of change management data returns a scoring value within the range of 60-79; and entering the assigned risk profile of “medium” into the risk matrix.

According to yet another aspect of the present disclosure, when executed, the instructions may further cause the processor to perform the following: assigning a risk profile of medium for the IT change management system when the application of big data and machine learning algorithm to the input of change management data returns a scoring value within the range of 80-100; and entering the assigned risk profile of “high” into the risk matrix.

According to an additional aspect of the present disclosure, when executed, the instructions may further cause the processor to perform the following: iteratively retraining of ML models; and updating future predictions based on the retrained ML models.

According to a further aspect of the present disclosure, when executed, the instructions may further cause the processor to perform the following: implementing ensemble learning that combines predictions from an ensemble of multiple machine learning classifiers; and determining, in response to implementing, a final prediction by majority voting.

According to yet another aspect of the present disclosure, when executed, the instructions may further cause the processor to perform the following: training the ensemble of multiple machine learning classifiers in parallel; and generating the final prediction by using a hard voting classifier to determine majority consensus of all classifiers.

According to a further aspect of the present disclosure, when executed, the instructions may further cause the processor to perform the following: splitting historical change data into groups based on values of predictor variables; implementing different sequences of splits until division of failures and non-failures are obtained that meet the predetermined dimension resulting a decision tree; and implementing the decision tree to classify pending changes as failures or successes.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing an IT change management module in accordance with an exemplary embodiment.

FIG. 2 illustrates an exemplary network diagram of an IT change management module in accordance with an exemplary embodiment.

FIG. 3 illustrates a system diagram for implementing an IT change management device with an IT change management module in accordance with an exemplary embodiment.

FIG. 4 illustrates a system diagram for implementing an IT change management module of FIG. 3 in accordance with an exemplary embodiment.

FIG. 5 illustrates an exemplary risk matrix in accordance with an exemplary embodiment.

FIG. 6 illustrates a flow chart for implementing an IT change management module in accordance with an exemplary embodiment.

FIG. 7 illustrates a block diagram of an exemplary use case where a machine learning pipeline is running in a cloud container in accordance with an exemplary embodiment.

FIG. 8 illustrates an exemplary table that displays a list of features that may be utilized by exemplary models generated by the IT change management module of FIG. 4 in accordance with an exemplary embodiment.

FIG. 9 illustrates exemplary predictive features that have been identified as having potential predictive power that can be integrated into additional models in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units, engines, tools, devices and/or modules. Those skilled in the art will appreciate that these blocks, units, engines, tools, devices, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, engines, tools, devices, and/or modules being implemented by microprocessors or similar, they may be programmed using software (e.g., microcode) to perform various functions discussed herein and may optionally be driven by firmware and/or software. Alternatively, each block, unit, engine, tool device, and/or module may be implemented by dedicated hardware, or as a combination of dedicated hardware to perform some functions and a processor (e.g., one or more programmed microprocessors and associated circuitry) to perform other functions. Also, each block, unit, engine, tool, device, and/or module of the example embodiments may be physically separated into two or more interacting and discrete blocks, units, engines, tools, devices, and/or modules without departing from the scope of the inventive concepts. Further, the blocks, units, engines, tools, devices, and/or modules of the example embodiments may be physically combined into more complex blocks, units, engines, tools, devices, and/or modules without departing from the scope of the present disclosure.

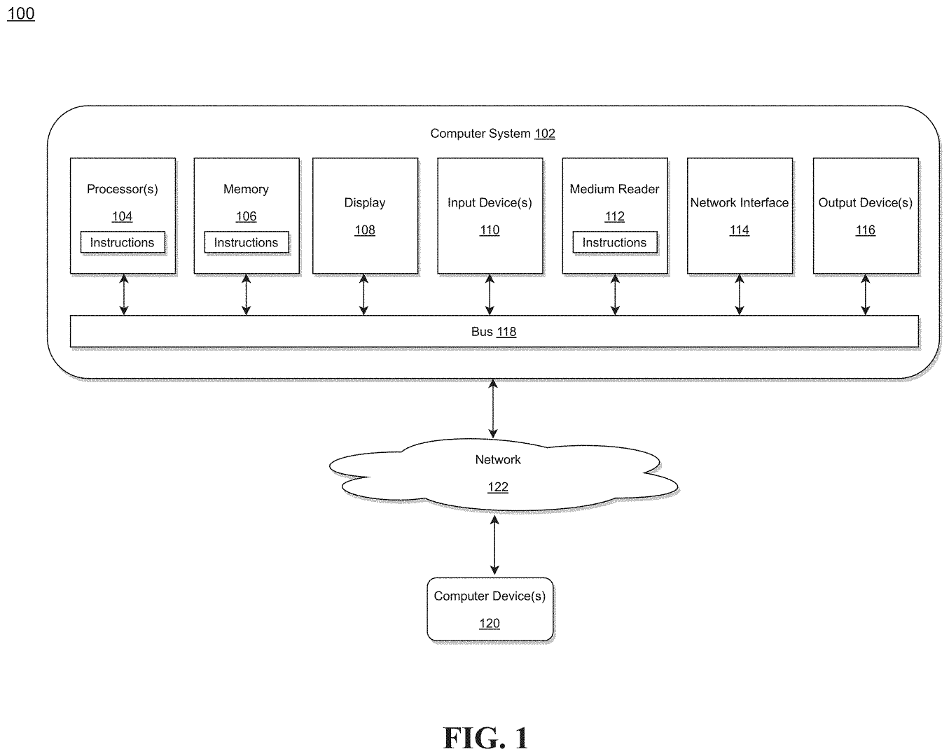

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized processes of implementing an IT change management system module for automatically calculating a risk profile based on a scoring scale by utilizing big data and machine learning algorithm, thereby improving the risk profile for IT change management system, but the disclosure is not limited thereto.

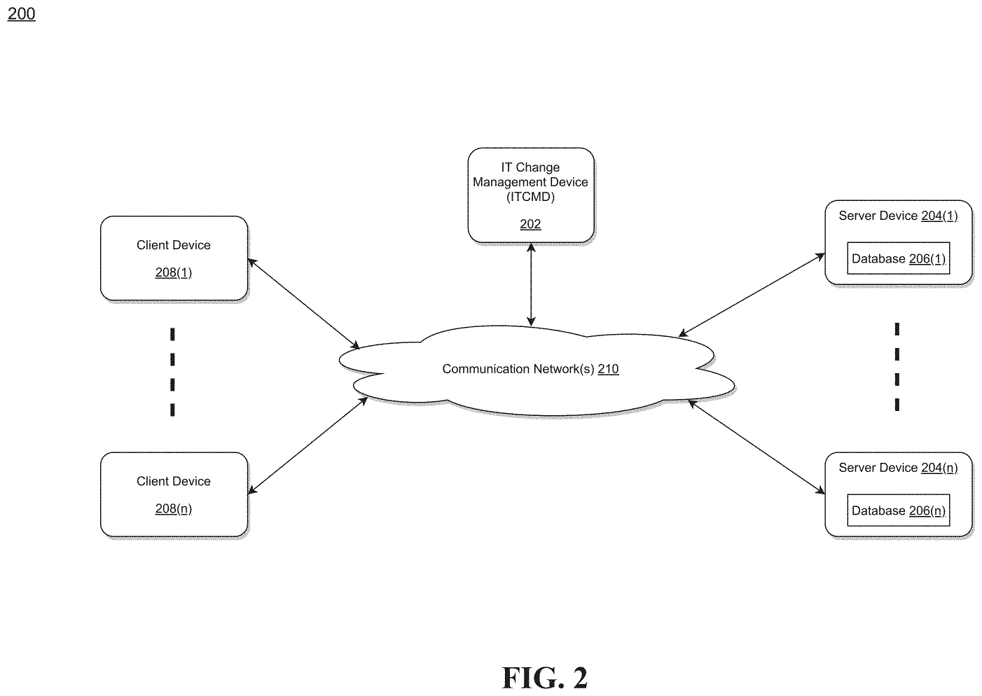

Referring to FIG. 2, a schematic of an exemplary network environment 200 for implementing an IT change management device (ITCMD) of the instant disclosure is illustrated.

According to exemplary embodiments, the above-described problems associated with conventional system may be overcome by implementing an ITCMD 202 having an IT change management module as illustrated in FIG. 2 to automatically calculating a risk profile based on a scoring scale by utilizing big data and machine learning algorithm, thereby improving the risk profile for IT change management system, but the disclosure is not limited thereto.

The ITCMD 202 may be the same or similar to the computer system 102 as described with respect to FIG. 1.

The ITCMD 202 may store one or more applications that can include executable instructions that, when executed by the ITCMD 202, cause the ITCMD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ITCMD 202 itself, may be located in virtual server(s) running in a cloud-based computing environment rather than being tied to one or more specific physical network computing devices. Also, the application(s) may be running in one or more virtual machines (VMs) executing on the ITCMD 202. Additionally, in one or more embodiments of this technology, virtual machine(s) running on the ITCMD 202 may be managed or supervised by a hypervisor.

In the network environment 200 of FIG. 2, the ITCMD 202 is coupled to a plurality of server devices 204(1)-204(n) that hosts a plurality of databases 206(1)-206(n), and also to a plurality of client devices 208(1)-208(n) via communication network(s) 210. A communication interface of the ITCMD 202, such as the network interface 114 of the computer system 102 of FIG. 1, operatively couples and communicates between the ITCMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ITCMD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ITCMD 202 may be a standalone device or integrated with one or more other devices or apparatuses, such as one or more of the server devices 204(1)-204(n), for example. In one particular example, the ITCMD 202 may be hosted by one of the server devices 204(1)-204(n), and other arrangements are also possible. Moreover, one or more of the devices of the ITCMD 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ITCMD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the ITCMD 202 that may be configured for automatically calculating a risk profile based on a scoring scale by utilizing big data and machine learning algorithm, thereby improving the risk profile for IT change management system, but the disclosure is not limited thereto.

Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example.

The client devices 208(1)-208(n) may run interface applications, such as standard web browsers or standalone client applications, which may provide an interface to communicate with the ITCMD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the ITCMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ITCMD 202, the server devices 204(1)-204(n), or the client devices 208(1)-208(n), for example, may be configured to operate as virtual instances on the same physical machine. For example, one or more of the ITCMD 202, the server devices 204(1)-204(n), or the client devices 208(1)-208(n) may operate on the same physical device rather than as separate devices communicating through communication network(s) 210. Additionally, there may be more or fewer ITCMDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks. Packet Data Networks (PDNs), the Internet, intranets, and combinations thereof.

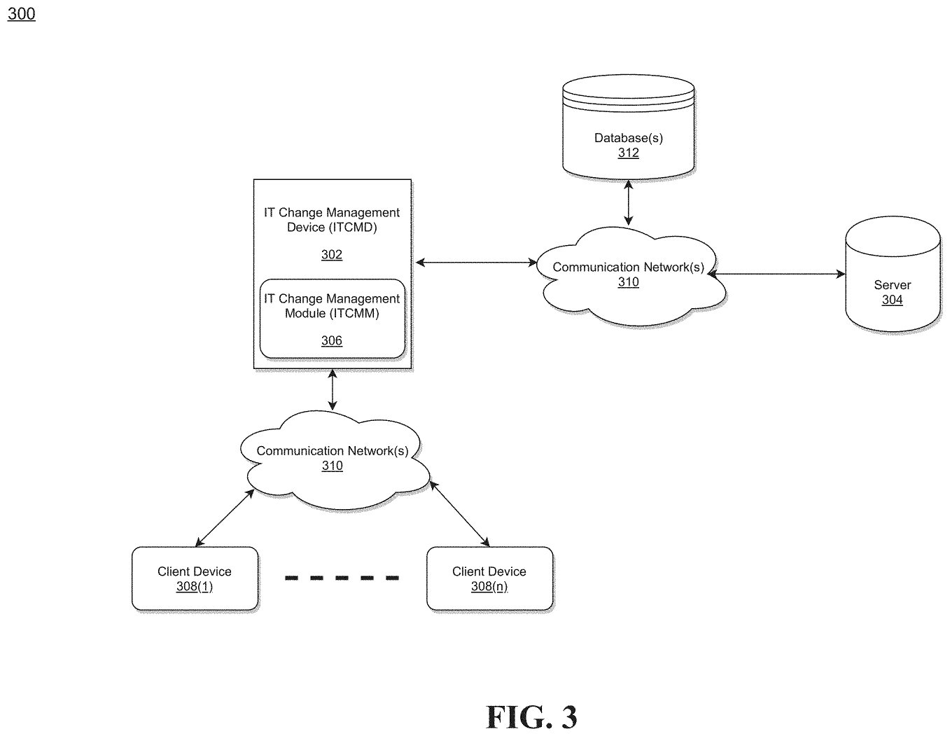

FIG. 3 illustrates a system diagram for implementing an ITCMD with an IT change management module (ITCMM) in accordance with an exemplary embodiment.

As illustrated in FIG. 3, in the system 300, according to exemplary embodiments, the ITCMD 302 including the ITCMM 306 may be connected to a server 304 and a database 312 via a communication network 310, but the disclosure is not limited thereto. For example, according to exemplary embodiments, the ITCMM 306 may be connected to any desired databases besides the database 312 and any internal databases (not shown).

According to exemplary embodiment, the ITCMD 302 is described and shown in FIG. 3 as including the ITCMM 306, although it may include other rules, policies, modules, databases, or applications, for example. According to exemplary embodiments, the database 312 may be embedded within the ITCMD 302. According to exemplary embodiments, the server 304 may also be a database which may be configured to store information including the metadata, but the disclosure is not limited thereto. According to exemplary embodiments, the ITCMD 302 and/or the ITCMM 306 may also be referred to as a processor.

According to exemplary embodiments, the ITCMM 306 may be configured to receive feed of data from the server 304 and the database 312 via the communication network 310. According to exemplary embodiments, the ITCMM 306 may also be configured to communicate with the client devices 308(1)-308(n) via the communication network 310, but the disclosure is not limited thereto.

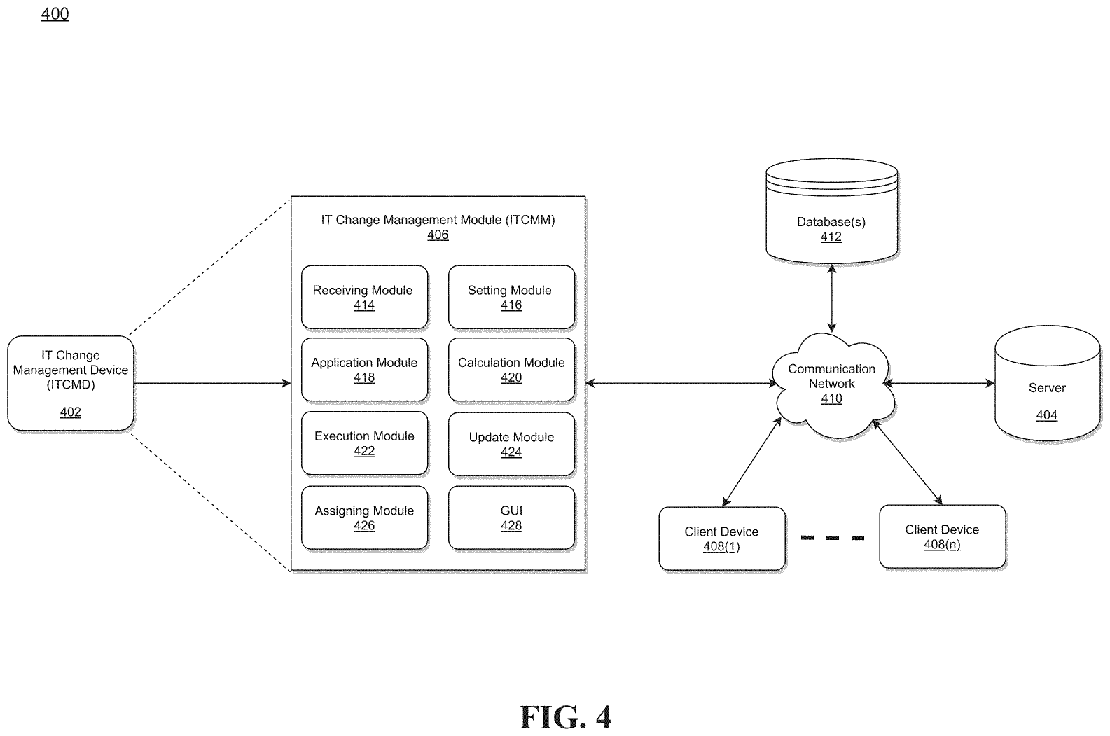

According to exemplary embodiments, artificial intelligence/Machine learning (AI/ML) models may be trained using CPUs and GPUs to infer decision based on received inputs as described with respect to FIGS. 4-6 below, but the disclosure is not limited thereto.

As will be described below, the ITCMM 306 may be configured to receive input of change management data associated with an IT change management system via an application programming interface (API); set a scoring scale; apply big data and machine learning algorithm to the input of change management data, wherein application of big data includes collecting the API associated with the input of change management data from a plurality of data sources; calculate a risk profile for the IT change management system corresponding to the input of change management data based on the scoring scale; and automatically generate a risk matrix having a predetermined dimension based on the calculated risk profile, but the disclosure is not limited thereto.

According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the client devices 308(1)-308(n) may communicate with the ITCMD 302 via broadband or cellular communication. Of course, these embodiments are merely exemplary and are not limiting or exhaustive.

FIG. 4 illustrates a system diagram for implementing an IT change management module (ITCMM) of FIG. 3 in accordance with an exemplary embodiment. As illustrated in FIG. 4, the system 400 may include an ITCMD 402 within which an ITCMM 406 may be embedded, a database 412, a server 404, a communication network 410, and one or more client devices 408(1)-408(n).

According to exemplary embodiments, as illustrated in FIG. 4, the ITCMM 406 may include a receiving module 414, a setting module 416, an application module 418, a calculation module 420, an execution module 422, an update module 424, an assigning module 426, and a GUI 428, but the disclosure is not limited thereto. Although FIG. 4 illustrates that the database 412 is embedded outside of the ITCMM 406, according to exemplary embodiments, the database 412 may be embedded within the ITCMM 406.

According to exemplary embodiments, the database 412 with reference to FIG. 4 may be same or similar to the database 312 as illustrated in FIG. 3. Further, the server 404 with reference to FIG. 4 may be same or similar to the server 304 as illustrated in FIG. 3, and the communication network 410 with reference to FIG. 4 may be same or similar to the communication network 310 as illustrated in FIG. 3.

According to exemplary embodiments, the ITCMM 406 may include various systems that are managed and operated by an organization by utilizing user's devices.

Referring to FIG. 4, the process may be executed via the communication network 410 which may comprise plural networks as described above. For example, in an exemplary embodiment, the various components of the ITCMM 406 may communicate with the database 412 and the server 304 via the communication network 410. Of course, these embodiments are merely exemplary and are not limiting or exhaustive. A plurality of client devices 408(1)-408(n) may be configured to be connected to the ITCMM 406 via the communication network 410.

According to exemplary embodiments, each of the receiving module 414, setting module 416, application module 418, calculation module 420, execution module 422, update module 424, and the assigning module 426 may be implemented by microprocessors or similar, they may be programmed using software (e.g., microcode) to perform various functions discussed herein. Alternatively, each of the receiving module 414, setting module 416, application module 418, calculation module 420, execution module 422, update module 424, and the assigning module 426 may be implemented by dedicated hardware, or as a combination of dedicated hardware to perform some functions and a processor (e.g., one or more programmed microprocessors and associated circuitry) to perform various functions discussed herein as well as other functions. Also, according to exemplary embodiments, each of the receiving module 414, setting module 416, application module 418, calculation module 420, execution module 422, update module 424, and the assigning module 426 may be physically separated into two or more interacting and discrete blocks, units, engines, devices, and/or modules without departing from the scope of the inventive concepts.

According to exemplary embodiments, each of the receiving module 414, setting module 416, application module 418, calculation module 420, execution module 422, update module 424, and the assigning module 426 of the ITCMM 406 may be called via corresponding API.

According to exemplary embodiments, the communication network 410 establishes a link among the ITCMM 406, the database 412, and the one or more client devices 408(1)-408(n).

According to exemplary embodiments, the receiving module 414 may be configured to receive input of change management data associated with an IT change management system via a user interface (e.g., GUI 428) or via an application programming interface (API).

According to exemplary embodiments, the setting module 416 may be configured to set a scoring scale.

According to exemplary embodiments, the application module 418 may be configured to apply big data and machine learning algorithm to the input of change management data. According to exemplary embodiments, application of big data may include collecting the API associated with the input of change management data from a plurality of data sources (e.g., database(s) 412).

According to exemplary embodiments, the calculation module 420 may be configured to calculate a risk profile for the IT change management system corresponding to the input of change management data based on the scoring scale and the execution module 422 may be configured to automatically generate a risk matrix having a predetermined dimension based on the calculated risk profile.

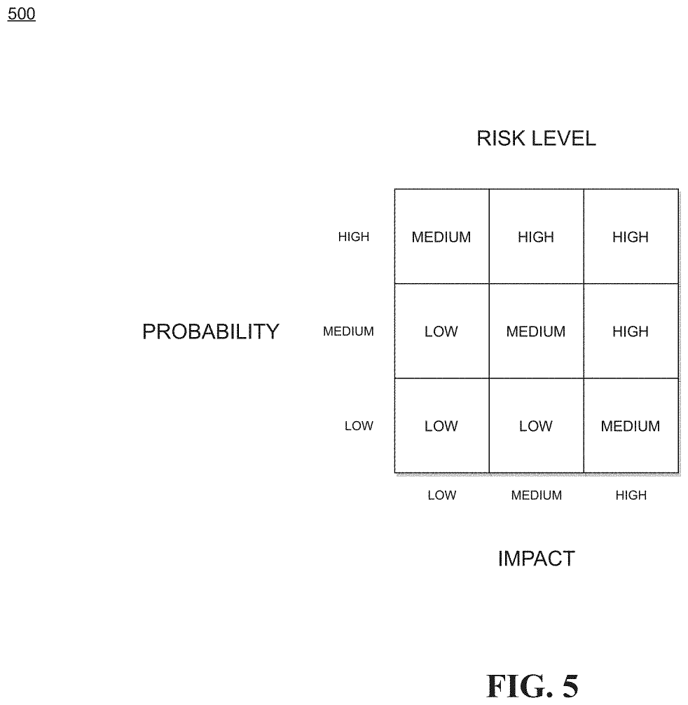

FIG. 5 illustrates an exemplary risk matrix 500. As illustrated in FIG. 5, the x-axis of the risk matrix may correspond to impact of IT change management system and the y-axis may correspond to probability of IT change management system. According to exemplary embodiments, the risk matrix 500 may be 3×3 matrix, but the disclosure is not limited thereto. Any other desired dimensional matrix may be automatically generated based on the calculated risk profile.

According to exemplary embodiments, the setting module 416 may be configured to set a scoring scale having numerical values within a range of 1-100. The calculating module 420 may be configured to calculate the risk profile based on the numerical values within the range of 1-100. The updating module 424 may be configured to dynamically update the risk matrix as new scoring values are generated.

According to exemplary embodiments, the assigning module 426 may be configured assign a risk profile of low for the IT change management system when the application of big data and machine learning algorithm to the input of change management data returns a scoring value within the range of 0-59 and the execution module 422 may be configured to enter the assigned risk profile of “low” into the risk matrix 500.

According to exemplary embodiments, the assigning module 426 may be configured assign a risk profile of low for the IT change management system when the application of big data and machine learning algorithm to the input of change management data returns a scoring value within the range of 60-79 and the execution module 422 may be configured to enter the assigned risk profile of “medium” into the risk matrix 500.

According to exemplary embodiments, the assigning module 426 may be configured assign a risk profile of low for the IT change management system when the application of big data and machine learning algorithm to the input of change management data returns a scoring value within the range of 80-100 and the execution module 422 may be configured to enter the assigned risk profile of “high” into the risk matrix 500.

According to an additional aspect of the present disclosure, the update module 424 may be configured to dynamically updating the risk matrix 500 by changing appropriate assigned risk profiles as new risk profiles are generated.

According to exemplary embodiments, a non-transitory computer readable medium may be configured to store instructions for implementing the ITCMM 406, but the disclosure is not limited thereto. According to exemplary embodiments, the instructions, when executed, may cause a processor embedded within the ITCMM 406 to perform the following: receiving input of change management data associated with an IT change management system via an API; setting a scoring scale; applying big data and machine learning algorithm to the input of change management data, wherein application of big data includes collecting the API associated with the input of change management data from a plurality of data sources; calculating a risk profile for the IT change management system corresponding to the input of change management data based on the scoring scale; and automatically generating a risk matrix having a predetermined dimension based on the calculated risk profile. The processor may be the same or similar to the processor 104 as illustrated in FIG. 1 or the processor embedded within ITCMD 202, ITCMD 302, ITCMM 306, ITCMD 402, and ITCMM 406.

According to exemplary embodiments, the instructions, when executed, may further cause the processor 104 to perform the following: setting a scoring scale having numerical values within a range of 1-100; calculating the risk profile based on the numerical values within the range of 1-100; and dynamically updating the risk matrix as new scoring values are generated.

According to exemplary embodiments, the instructions, when executed, may further cause the processor 104 to perform the following: assigning a risk profile of low for the IT change management system when the application of big data and machine learning algorithm to the input of change management data returns a scoring value within the range of 0-59; and entering the assigned risk profile of “low” into the risk matrix.

According to exemplary embodiments, the instructions, when executed, may further cause the processor 104 to perform the following: assigning a risk profile of medium for the IT change management system when the application of big data and machine learning algorithm to the input of change management data returns a scoring value within the range of 60-79; and entering the assigned risk profile of “medium” into the risk matrix.

According to exemplary embodiments, the instructions, when executed, may further cause the processor 104 to perform the following: assigning a risk profile of medium for the IT change management system when the application of big data and machine learning algorithm to the input of change management data returns a scoring value within the range of 80-100; and entering the assigned risk profile of “high” into the risk matrix.

According to exemplary embodiments, the instructions, when executed, may further cause the processor 104 to iteratively retrain ML models; and updating future predictions based on the retrained ML models.

According to exemplary embodiments, the instructions, when executed, may further cause the processor 104 to perform the following: implementing ensemble learning that combines predictions from an ensemble of multiple machine learning classifiers; and determining, in response to implementing, a final prediction by majority voting.

According to exemplary embodiments, the instructions, when executed, may further cause the processor 104 to perform the following: training the ensemble of multiple machine learning classifiers in parallel; and generating the final prediction by using a hard voting classifier to determine majority consensus of all classifiers.

According to exemplary embodiments, the instructions, when executed, may further cause the processor 104 to perform the following: splitting historical change data into groups based on values of predictor variables; implementing different sequences of splits until division of failures and non-failures are obtained that meet the predetermined dimension resulting a decision tree; and implementing the decision tree to classify pending changes as failures or successes.

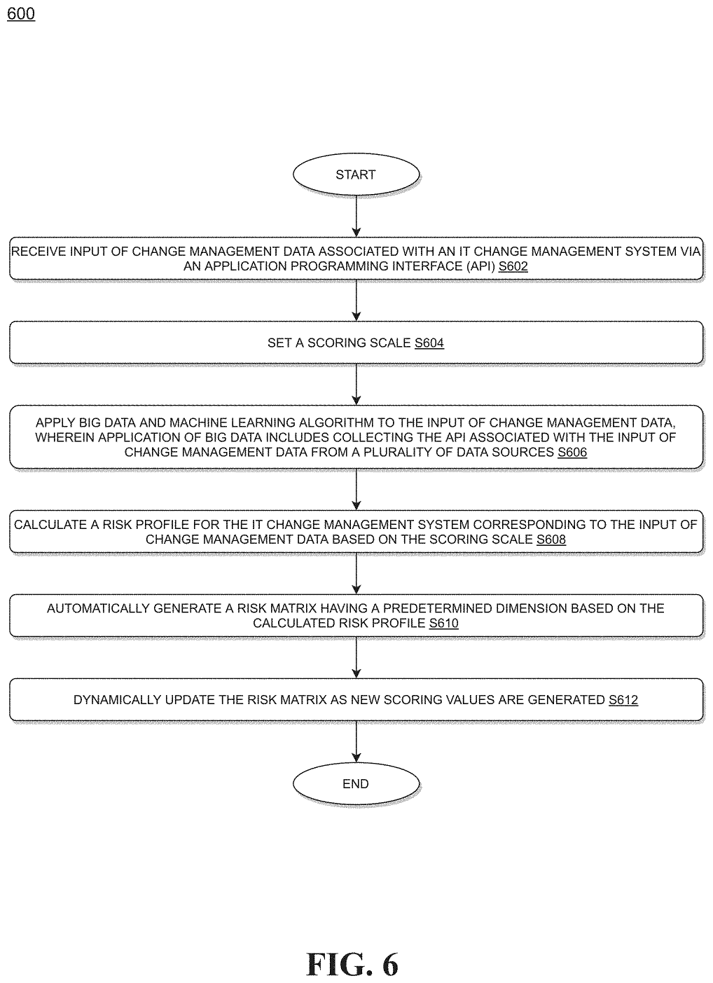

FIG. 6 illustrates a flow chart for implementing an IT change management module for improving risk profile for IT change management system in accordance with an exemplary embodiment.

It will be appreciated that the illustrated process 600 and associated steps may be performed in a different order, with illustrated steps omitted, with additional steps added, or with a combination of reordered, combined, omitted, or additional steps.

In the process 600 of FIG. 6, at step S602, input of change management data associated with an IT change management system may be received via a user interface.

According to exemplary embodiments, at step S604, a scoring scale may be set.

According to exemplary embodiments, at step S606, big data and machine learning algorithm may be applied to the input of change management data, wherein application of big data may include collecting application programming interface (API) associated with the input of change management data from a plurality of data sources.

According to exemplary embodiments, at step S608, a risk profile may be calculated for the IT change management system corresponding to the input of change management data based on the scoring scale.

At step S610, a risk matrix having a predetermined dimension may be automatically generated based on the calculated risk profile.

According to exemplary embodiments, the process 600 may further include: setting a scoring scale having numerical values within a range of 1-100; calculating the risk profile based on the numerical values within the range of 1-100; and dynamically updating the risk matrix as new scoring values are generated.

According to exemplary embodiments, the process 600 may further include: assigning a risk profile of low for the IT change management system when the application of big data and machine learning algorithm to the input of change management data returns a scoring value within the range of 0-59; and entering the assigned risk profile of “low” into the risk matrix.

According to exemplary embodiments, the process 600 may further include: assigning a risk profile of medium for the IT change management system when the application of big data and machine learning algorithm to the input of change management data returns a scoring value within the range of 60-79; and entering the assigned risk profile of “medium” into the risk matrix.

According to exemplary embodiments, the process 600 may further include: assigning a risk profile of medium for the IT change management system when the application of big data and machine learning algorithm to the input of change management data returns a scoring value within the range of 80-100; and entering the assigned risk profile of “high” into the risk matrix.

According to exemplary embodiments, the process 600 may further include: iteratively retraining of ML models; and updating future predictions based on the retrained ML models.

According to exemplary embodiments, the process 600 may further include: implementing ensemble learning that combines predictions from an ensemble of multiple machine learning classifiers; and determining, in response to implementing, a final prediction by majority voting.

According to exemplary embodiments, the process 600 may further include: training the ensemble of multiple machine learning classifiers in parallel; and generating the final prediction by using a hard voting classifier to determine majority consensus of all classifiers.

According to exemplary embodiments, the process 600 may further include: splitting historical change data into groups based on values of predictor variables; implementing different sequences of splits until division of failures and non-failures are obtained that meet the predetermined dimension resulting a decision tree; and implementing the decision tree to classify pending changes as failures or successes.

According to exemplary embodiments, ITCMM 406 of FIG. 4 may be configured to develop and evaluate predictive models to discover whether data-driven analytics can more accurately predict the likelihood of failures and incidents. Exemplary objectives may include, but not limited thereto to predict with greater accuracy than is currently possible whether a change is likely to fail and/or cause an incident prior to implementation.

For example, according to exemplary embodiments, the ITCMM 406 may be configured to review production data to identify features with potential ‘predictive power;’ create prediction hypotheses, for example, “do the number of project tracking systems and the number of applications impacted by a change impacts the success or failure of that change?” etc. The ITCMM 406 may further be configured to select a machine learning (ML) model and develop a ML pipeline locally using high-level general-purpose programming language, e.g., Python, but the disclosure is not limited thereto; prepare data for consumption by model; evaluate model and measure accuracy using F1-score (also known as balanced F-score or F-measure) etc., but the disclosure is not limited thereto. According to exemplary embodiments, the F1 score can be interpreted as a weighted average of the precision and recall, where an F1 score reaches its best value at 1 and worst score at 0. The relative contribution of precision and recall to the F1 score are equal. The formula for the F1 score is: F1=2*(precision*recall)/(precision+recall). In a multi-class and multi-label case, this is the average of the F1 score of each class with weighting depending on the average parameter, but the disclosure is not limited thereto.

According to exemplary embodiments, the ITCMM 406 may further be configured to refine model (add, remove or combine features; modify classifiers, etc., but the disclosure is not limited thereto); deploy to cloud and automate pipeline; and integrate results into a web front-end and an IT Change Management Risk Model, etc., but the disclosure is not limited thereto.

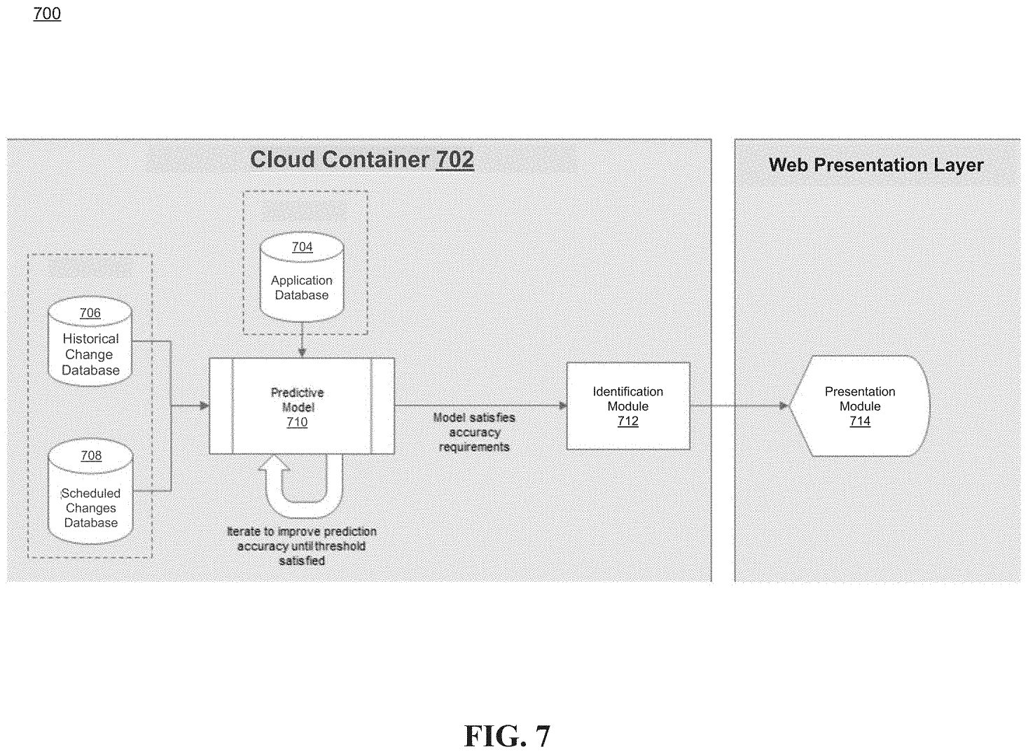

For example, FIG. 7 illustrates an exemplary block diagram 700 of an exemplary use case where machine learning pipeline is running in a cloud container 702. As illustrated in FIG. 7, the exemplary block diagram includes an application database 704, a historical change database 706, a scheduled changes database 708, a predictive model 710, an identification module 712, and a presentation module 714. According to exemplary embodiments, the predictive model 710 may be generated by the ITCMM 406 based on data received from the application database 704, the historical change database 706, and the scheduled changes database 708. The ITCMM 406 may be configured to iterate the predictive model to improve prediction accuracy until a predetermined threshold is satisfied. When the predictive model 710 is determined to satisfy accuracy requirements, the identification module 712 may be configured to identify high risk changes based on the predictive model 710. The presentation module 714 may be configured to present change failure probability for scheduled changes in production health data, but the disclosure is not limited thereto.

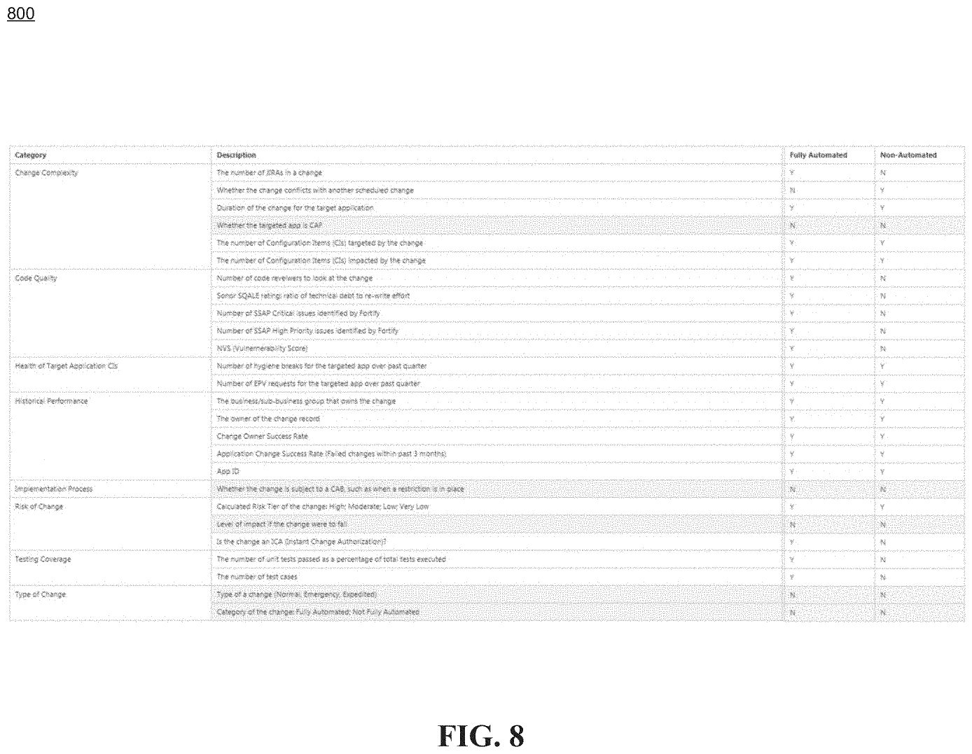

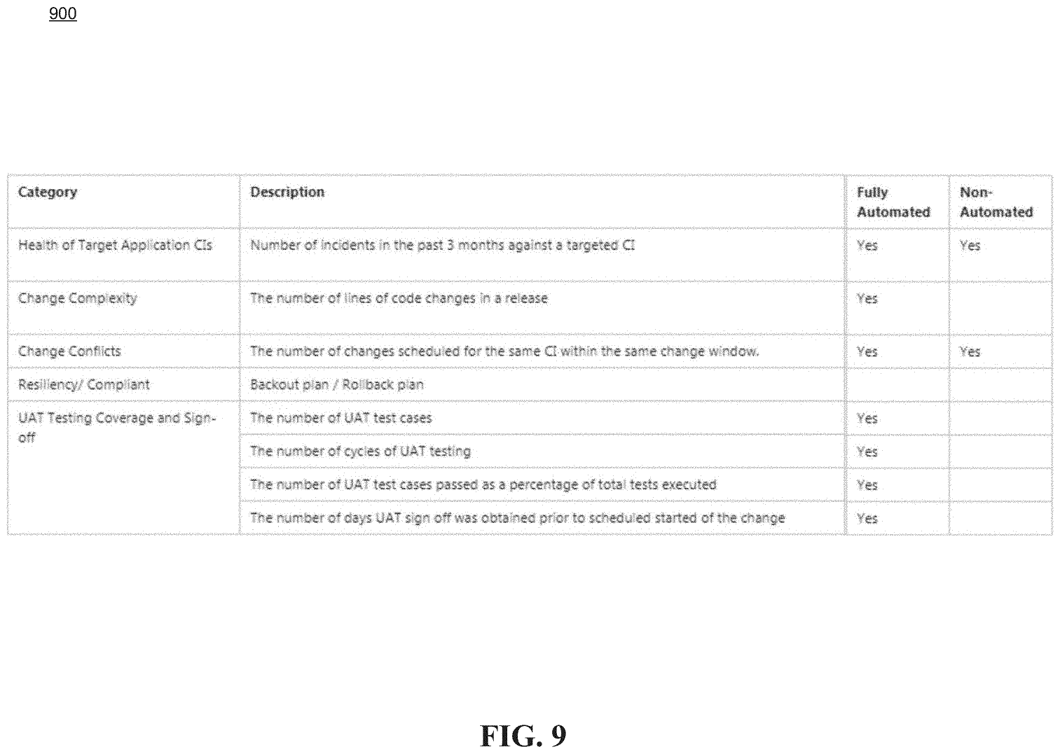

According to exemplary embodiments, there may be two models in place for predicting failed change: one for fully automated changes, and one for non-automated changes. For example, FIG. 8 illustrates an exemplary table 800 that displays a list of features that may be utilized by exemplary models generated by the ITCMM 406 of FIG. 4 in accordance with an exemplary embodiment. FIG. 9 illustrates exemplary predictive features that have been identified as having potential predictive power and, if accuracy thresholds met, integrated into additional models.

According to exemplary embodiments, the ITCMM 406 may be configured to implement the following processes in model selection: implementing ensemble learning that combines predictions from multiple ML classifiers and determines the final output by majority voting; training an ensemble of multiple classifiers in parallel; and generating the final prediction by using a hard voting classifier to determine the majority consensus of all classifiers, but the disclosure is not limited thereto. Combining the results of a diverse set of classifiers using voting implemented by the ITCMM 406 yielded better accuracy than using any other single one.

According to exemplary embodiments, inputs to models may include historic change management (or Request for Change) data and data relating to the health of impacted Configuration Items (CIs), but the disclosure is not limited thereto.

According to exemplary embodiments, output may include a revised risk profile and/or a binary classification for whether a change is likely to succeed or likely to fail.

According to exemplary embodiments as disclosed above in FIGS. 1-6, technical improvements effected by the instant disclosure may include platforms for implementing an IT change management module for automatically calculating a risk profile based on a scoring scale by utilizing big data and machine learning algorithm, thereby improving the risk profile for IT change management system, but the disclosure is not limited thereto. According to exemplary embodiments as disclosed above in FIGS. 1-6, technical improvements effected by the instant disclosure may further include platforms for implementing an IT change management module for automatically calculating a risk profile based on a scoring scale by utilizing big data and machine learning algorithm (i.e., artificial intelligence (AI)/machine learning (ML) models), thereby reducing downtime by focusing on true high and critical risk changes; resulting reduction in client/customer impacts by avoiding manual entry and incorrect risk assessment; and increasing in production stability due to increased awareness of high and critical risk changes, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for improving risk profile for information technology (IT) change management system by utilizing one or more processors and one or more memories, the method comprising:
receiving input of change management data associated with an IT change management system via an application programming interface (API);
setting a scoring scale;
applying big data and machine learning algorithm to the input of change management data, wherein application of big data includes collecting the API associated with the input of change management data from a plurality of data sources;
calculating a risk profile for the IT change management system corresponding to the input of change management data based on the scoring scale; and
automatically generating a risk matrix having a predetermined dimension based on the calculated risk profile.

2. The method according to claim 1, further comprising:
setting a scoring scale having numerical values within a range of 1-100;
calculating the risk profile based on the numerical values within the range of 1-100; and
dynamically updating the risk matrix as new scoring values are generated.

3. The method according to claim 2, further comprising:
assigning a risk profile of low for the IT change management system when the application of big data and machine learning algorithm to the input of change management data returns a scoring value within the range of 0-59; and
entering the assigned risk profile of “low” into the risk matrix.

4. The method according to claim 2, further comprising:
assigning a risk profile of medium for the IT change management system when the application of big data and machine learning algorithm to the input of change management data returns a scoring value within the range of 60-79; and
entering the assigned risk profile of “medium” into the risk matrix.

5. The method according to claim 2, further comprising:
assigning a risk profile of high for the IT change management system when the application of big data and machine learning algorithm to the input of change management data returns a scoring value within the range of 80-100; and
entering the assigned risk profile of “high” into the risk matrix.

6. The method according to claim 1, further comprising:
iteratively retraining machine learning (ML) models; and
updating future predictions based on the retrained ML models.

7. The method according to claim 1, further comprising:
implementing ensemble learning that combines predictions from an ensemble of multiple machine learning classifiers; and
determining, in response to implementing, a final prediction by majority voting.

8. The method according to claim 7, further comprising:
training the ensemble of multiple machine learning classifiers in parallel; and
generating the final prediction by using a hard voting classifier to determine majority consensus of all classifiers.

9. The method according to claim 1, further comprising:
splitting historical change data into groups based on values of predictor variables;
implementing different sequences of splits until division of failures and non-failures are obtained that meet the predetermined dimension resulting a decision tree; and
implementing the decision tree to classify pending changes as failures or successes.

10. A system for improving risk profile for information technology (IT) change management, comprising:
a plurality of data sources including memories; and
a processor operatively connected to the plurality of data sources via a communication network, wherein the processor is configured to:
receive input of change management data associated with an IT change management system via an application programming interface (API);
set a scoring scale;
apply big data and machine learning algorithm to the input of change management data, wherein application of big data includes collecting the API associated with the input of change management data from a plurality of data sources;
calculate a risk profile for the IT change management system corresponding to the input of change management data based on the scoring scale; and
automatically generate a risk matrix having a predetermined dimension based on the calculated risk profile.

11. The system according to claim 10, wherein the processor is further configured to:
set a scoring scale having numerical values within a range of 1-100:
calculate the risk profile based on the numerical values within the range of 1-100; and
dynamically update the risk matrix as new scoring values are generated.

12. The system according to claim 11, wherein the processor is further configured to:
assign a risk profile of low for the IT change management system when the application of big data and machine learning algorithm to the input of change management data returns a scoring value within the range of 0-59; and
enter the assigned risk profile of “low” into the risk matrix.

13. The system according to claim 11, wherein the processor is further configured to:
assign a risk profile of medium for the IT change management system when the application of big data and machine learning algorithm to the input of change management data returns a scoring value within the range of 60-79; and
enter the assigned risk profile of “medium” into the risk matrix.

14. The system according to claim 11, wherein the processor is further configured to:
assign a risk profile of high for the IT change management system when the application of big data and machine learning algorithm to the input of change management data returns a scoring value within the range of 80-100; and
enter the assigned risk profile of “high” into the risk matrix.

15. The system according to claim 10, wherein the processor is further configured to:
iteratively retrain machine learning (ML) models; and
update future predictions based on the retrained ML models.

16. The system according to claim 10, wherein the processor is further configured to:
implement ensemble learning that combines predictions from an ensemble of multiple machine learning classifiers; and
determine, in response to implementing, a final prediction by majority voting.

17. The system according to claim 16, wherein the processor is further configured to:
train the ensemble of multiple machine learning classifiers in parallel; and
generate the final prediction by using a hard voting classifier to determine majority consensus of all classifiers.

18. The system according to claim 10, wherein the processor is further configured to:
split historical change data into groups based on values of predictor variables;
implement different sequences of splits until division of failures and non-failures are obtained that meet the predetermined dimension resulting a decision tree; and
implement the decision tree to classify pending changes as failures or successes.

19. A non-transitory computer readable medium configured to store instructions for improving risk profile for information technology (IT) change management, wherein, when executed, the instructions cause a processor to perform the following:
receiving input of change management data associated with an IT change management system via an application programming interface (API);
setting a scoring scale;
applying big data and machine learning algorithm to the input of change management data, wherein application of big data includes collecting the API associated with the input of change management data from a plurality of data sources;
calculating a risk profile for the IT change management system corresponding to the input of change management data based on the scoring scale; and
automatically generating a risk matrix having a predetermined dimension based on the calculated risk profile.

20. The non-transitory computer readable medium according to claim 19, wherein, when executed, the instructions cause the processor to further perform the following:
set a scoring scale having numerical values within a range of 1-100;
calculate the risk profile based on the numerical values within the range of 1-100; and
dynamically update the risk matrix as new scoring values are generated.
